(19) United States
(12) Patent Application Publication
(10) Pub. No.: US 2025/0123629 A1
(43) Pub. Date: Apr. 17, 2025

(54) Vehicle, System for Steering Control, Method, Program, Recording Medium Storing Program, and Autonomous Travelling System

(71) Applicant: Mamiya-OP Co., Ltd., Saitama (JP)

(72) Inventors: Satoru Suzuki, Tokyo (JP); Takafumi Suzuki, Tokyo (JP); Hiroshi Sugawara, Tokyo (JP)

(21) Appl. No.: 18/889,253

(22) Filed: Sep. 18, 2024

Related U.S. Application Data
(63) Continuation of application No. 18/705,283, filed on Jan. 1, 0001.

(51) Int. Cl. G05D 1/244; A01D 34/00; A01D 101/00; G05D 1/248; G05D 105/15; G05D 111/30

(52) U.S. Cl. CPC G05D 1/244; A01D 34/008; A01D 2101/00; G05D 1/248; G05D 2105/15; G05D 2111/36

(57) ABSTRACT

A steering control system for a vehicle that detects a magnetic field generated from an electromagnetic induction line and that is capable of autonomous travelling along said electromagnetic induction line, where the steering control system includes: a plurality of induction line detection sensors attached to said vehicle; and a control device that, for every control cycle and on the basis of a deviation of said vehicle from said electromagnetic induction line calculated from detection data acquired by said plurality of induction line detection sensors, generates and outputs a travelling control signal that causes said vehicle to turn so as to cancel the deviation or causes said vehicle to advance straight forward, wherein a deviation detection reference point of said plurality of induction line detection sensors is disposed at a position separated from a pivot serving as the turning center of said vehicle.

### PRIORITY

The present disclosure is a continuation of, and claims priority to, U.S. patent application Ser. No. 18/705,283 filed Apr. 26, 2024, which is a U.S. National Phase Application under 35 U.S.C. § 371 of International Application No. PCT/JP2021/039882 filed Oct. 28, 2021, and entitled “Vehicle, System for Steering Control, Method, Program, Recording Medium Storing Program, and Autonomous Travelling System”, both of which are incorporated herein by reference in their entirety.

### TECHNICAL FIELD

The present invention relates to an autonomous travelling vehicle, a system, method and program for the steering control of an autonomous travelling vehicle, a recording medium in which a program is recorded, and an autonomous travelling system.

### BACKGROUND ART

An autonomous travelling system is known, where this system supplies an alternating current to an electromagnetic induction line embedded on a road surface, detects an AC magnetic field generated thereby by means of two magnetic sensors disposed at equal intervals to the left and right relative to the center line of the vehicle, determines the position of the electromagnetic induction line by detecting the induced electromotive force generated at the two magnetic sensors, performs steering on the basis of the position of the electromagnetic induction line which was determined, and causes a vehicle to travel along the electromagnetic induction line (refer e.g. to Patent Literature 1).

### CITATION LIST

### Patent Literature

Patent Literature 1: JP 2003-005832 A

### SUMMARY OF INVENTION

### Technical Problem

However, there are problems in the conventional autonomous travelling system by means of an electromagnetic induction line as described in the aforementioned Patent Literature 1 in that, for example: (1) large-scale laying construction work is necessary, (2) autonomous travel cannot be made on paths outside of the electromagnetic induction line path, and (3) the power source to supply electric power must be large-scaled because of the need to supply electric power to long-distance electromagnetic induction lines.

Moreover, in an autonomous travelling system by means of an electromagnetic induction line, it is necessary to perform control so that a vehicle does not deviate from the electromagnetic induction line.

Thus, an objective of the present invention is to provide an autonomous travelling system by means of electromagnetic induction, in which large-scale laying construction work and large-scale power source are not required.

Moreover, an objective of the present invention is to enable control so that a vehicle does not deviate from an electromagnetic induction line.

### Solution to Problem

An aspect of the present invention is to provide a steering control system for a vehicle that detects a magnetic field generated from an electromagnetic induction line and that is capable of autonomously travelling along the electromagnetic induction line, wherein the steering control system comprises: a plurality of induction line detection sensors attached to said vehicle; and a control device that, for every control cycle and on the basis of a deviation of said vehicle from said electromagnetic induction line calculated from detection data acquired by said plurality of induction line detection sensors, generates and outputs a travelling control signal causing said vehicle to turn so as to cancel the deviation, or causing said vehicle to advance straight forward, wherein a deviation detection reference point of said plurality of induction line detection sensors is disposed at a position separated from a pivot serving as the turning center of said vehicle, at a forward side by a distance I[m] in the horizontal direction, and if said control cycle is configured as t[seconds], a velocity when said vehicle is travelling on said electromagnetic induction line is configured as v[m/seconds], a deviation tolerance width in the horizontal direction from said electromagnetic induction line of said deviation detection reference point is configured as D[m], and the smallest turning radius of said vehicle is configured as R[m], then said distance I[m] is tv[m] or more and

$$\sqrt{{R}^{2} - {( R - D )}^{2}} [ m ] \qquad [ Formula 1 ]$$

or less.

Said plurality of induction line detection sensors can be configured to be a center induction line detection sensor, a left side induction line detection sensor, and a right side induction line detection sensor, and said deviation detection reference point can be configured to be disposed on the central line of said vehicle, the center induction line detection sensor can be configured to be disposed at said deviation detection reference point, and said left side induction line detection sensor and said right side induction line detection sensor can be configured to be respectively disposed on a straight line perpendicular to the central line of said vehicle passing through said center induction line detection sensor, at the left side and right side of said center induction line detection sensor.

Said deviation tolerance width can be configured to be a maximum detection distance from said center induction line detection sensor, which is the maximum distance in the horizontal direction of said center induction line detection sensor capable of detecting said magnetic field.

Said vehicle can be configured to be provided with a front wheel and a rear wheel, wherein said front wheel is a driving wheel, said rear wheel is a steering wheel, and the center of an axle of said front wheel is the pivot.

An aspect of the present invention is to provide a vehicle including a travelling drive mechanism to drive self-travel on the basis of said travelling control signal output from said steering control system.

An aspect of the present invention is to provide a steering control method for a vehicle that detects a magnetic field generated from an electromagnetic induction line and that is capable of autonomously travelling along said electromagnetic induction line, wherein in the steering control method, a plurality of induction line detection sensors are attached to said vehicle, for every control cycle and on the basis of a deviation of said vehicle from the electromagnetic induction line calculated from detection data acquired by said plurality of induction line detection sensors, a travelling control signal is generated and output that causes said vehicle to turn so as to cancel the deviation or causes said vehicle to advance straight forward, a deviation detection reference point of said plurality of induction line detection sensors is disposed at a position separated from a pivot serving as the turning center of said vehicle, at a forward side by a distance I[m] in the horizontal direction, and if said control cycle is configured as t[seconds], a velocity when said vehicle is travelling on said electromagnetic induction line is configured as v[m/seconds], a deviation tolerance width in the horizontal direction from said electromagnetic induction line of said deviation detection reference point is configured as D[m], and the smallest turning radius of said vehicle is configured as R[m], then said distance I[m] is tv[m] or greater and

$$\sqrt{{R}^{2} - {( R - D )}^{2}} [ m ] \qquad [ Formula 2 ]$$

or less.

Said plurality of induction line detection sensors can be configured to be a center induction line detection sensor, a left side induction line detection sensor, and a right side induction line detection sensor, and said deviation detection reference point is disposed on the central line of said vehicle, the center induction line detection sensor is disposed at said deviation detection reference point, and said left side induction line detection sensor and said right side induction line detection sensor can be configured to be respectively disposed on a straight line passing through said center induction line detection sensor perpendicular to the central line of said vehicle, at the left side and right side of said center induction line detection sensor.

Said deviation tolerance width can be configured to be a maximum detection distance from said center induction line detection sensor, which is the maximum distance in the horizontal direction of said center induction line detection sensor capable of detecting said magnetic field.

Said vehicle can be configured to be provided with a front wheel and a rear wheel, wherein said front wheel is a driving wheel and said rear wheel is a steering wheel, and the center of an axle of said front wheel is the pivot.

An aspect of the present invention is to provide a computer program for executing said steering control method in a computer.

An aspect of the present invention is to provide a computer readable recording medium in which said computer program is recorded.

An aspect of the present invention is to provide an autonomous travelling system for a vehicle that detects a magnetic field generated from an electromagnetic induction line and that is capable of autonomously travelling along said electromagnetic induction line, said system comprising: a plurality of closed loop electromagnetic induction lines disposed adjacent to each other; and a power source device respectively corresponding to said plurality of closed loop electromagnetic induction lines, wherein: a portion of each of said plurality of closed loop electromagnetic induction lines are disposed adjacent to each other so as form a travelling path; and a power source device corresponding to each of said plurality of closed loop electromagnetic induction lines are respectively connected, and a low-frequency alternating current of the same frequency is supplied from said power source device to said plurality of closed loop electromagnetic induction line.

Said low-frequency alternating current of the same frequency can be configured to be synchronized.

Said vehicle can be configured to include, as autonomous travelling modes, a positioning mode where autonomous travelling takes place on the basis of a received positioning signal, and an electromagnetic induction mode where autonomous travelling takes place along a electromagnetic induction line by detecting a magnetic field generated from said electromagnetic induction line, wherein autonomous travelling takes place by said positioning mode on a path where said electromagnetic induction line has not been laid.

Said electromagnetic induction line of a travelling path can be configured to be laid at a portion where a positioning signal cannot be received, or where the receiving strength of a positioning signal is weak.

Said vehicle can be configured as a vehicle including a travelling drive mechanism to drive self-travel on the basis of said travelling control signal output from said steering control system.

### Advantageous Effects of Invention

According to the present invention having the aforementioned configurations, an autonomous travelling system by means of electromagnetic induction which does not require large-scale laying construction work and large-scale power source can be provided.

Moreover, according to the present invention having the aforementioned configurations, a vehicle can be controlled so as not to deviate from an electromagnetic induction line.

### BRIEF DESCRIPTION OF DRAWINGS

FIG. 1 is an entire schematic diagram of a device and the like required in the autonomous travelling of a lawn mower in lawn mowing work, according to one embodiment of the present invention.

FIG. 2 is a side surface external view of a lawn mower according to one embodiment to which the present invention is applied.

FIG. 3 is an upper surface conceptual drawing of the main components of a lawn mower according to one embodiment of the present invention.

FIG. 4 is a drawing illustrating the relationship between the deviation of the induction line detection sensor from the electromagnetic induction line, and a positional relationship between the electromagnetic induction line and induction line detection sensor.

FIG. 5 is a drawing illustrating a geometrical relationship when travelling autonomously on an electromagnetic induction line.

FIG. 6 is a drawing illustrating the relationship between the trajectory of a pivot and the trajectory of the center induction line detection sensor.

FIG. 7 is a drawing illustrating the relationship between the trajectory of a pivot and the trajectory of the center induction line detection sensor.

FIG. 8 is a drawing illustrating the relationship between the trajectory of a pivot and the trajectory of the center induction line detection sensor.

FIG. 9 is a drawing illustrating the relationship between the trajectory of a pivot and the trajectory of the center induction line detection sensor.

FIG. 10 is a flowchart of an example of a steering control process according to one embodiment of the present invention.

FIG. 11 is a drawing illustrating one example of a travelling path.

FIG. 12 is a drawing illustrating an entire configuration of the autonomous travelling system according to one embodiment of the present invention.

FIG. 13 is a drawing illustrating one example of an alternating current and synchronization signal supplied to an electromagnetic induction line.

FIG. 14 are comparative drawings of the electric field strengths when the phases of the alternating currents of adjacent closed loop electromagnetic induction lines are matching and when they are shifted.

Explained below as an example is the case in which the steering control system of the present invention, a vehicle to which the steering control system of the present invention is mounted, and the autonomous travelling system of the present invention, are applied to a lawn mower which mows the lawn of a golf course.

### <Overall Outline>

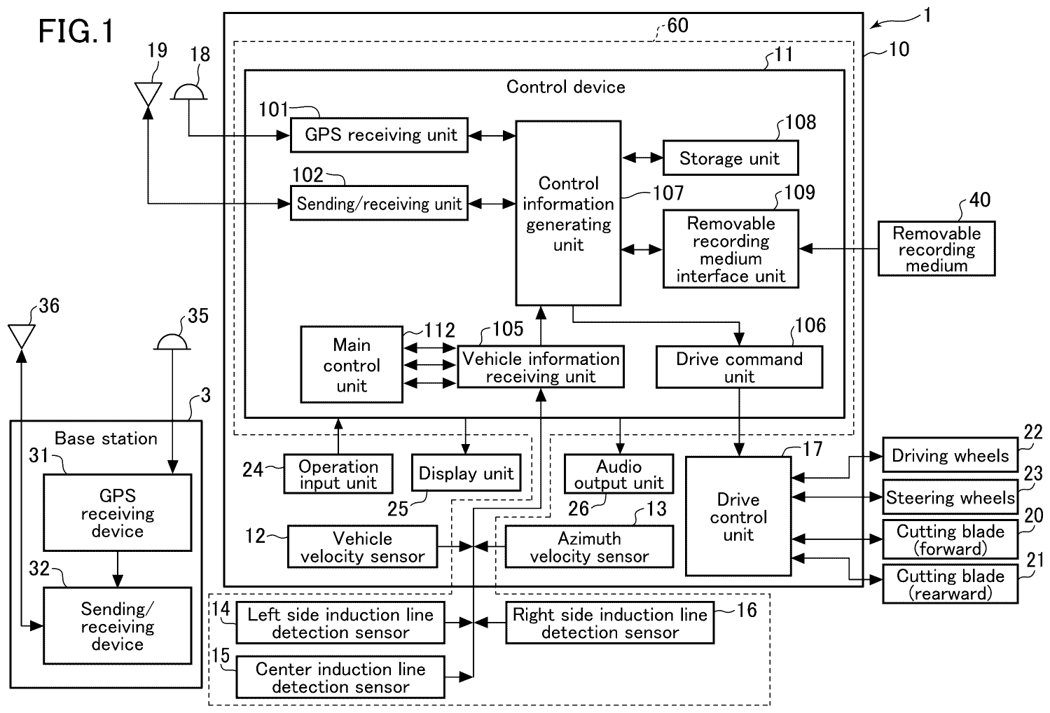

FIG. 1 is an entire schematic diagram of a device and the like necessary in the autonomous travelling of a lawn mower, according to one embodiment of the present invention. The present embodiment illustrates an example of a lawn mower 1 of which lawn mowing work at a golf course takes place whilst performing measurements of the present position, by means of the RTK-GPS system (Real Time Kinematic GPS: interferometric positioning system).

A base station 3 is provided with a GPS receiving device 31 and a sending/receiving device 32 which are equivalent to the RTK-GPS reference station, a GPS antenna 35, and a communication antenna 36. The base station 3 is installed at a site where the latitude, longitude and elevation of the station are already known. The GPS receiving device 31 generates correction information for amending positional information errors of the lawn mower 1. This correction information is suitably sent to the lawn mower 1 via the sending/receiving device 32 and communication antenna 36. The timing for sending the correction information is, for example, when demanded by the lawn mower 1, or at predetermined intervals (e.g. every 100 ms).

In the present embodiment, the RTK-GPS system is used as the positioning system; however, the Differential GPS system (Differential GPS: relative positioning system) may also be used.

The lawn mower 1 is provided with a body 10, control device 11, a vehicle velocity sensor 12, an azimuth velocity sensor 13, a left side induction line detection sensor 14, a center induction line detection sensor 15, a right side induction line detection sensor 16, a drive control unit 17, a GPS antenna 18, a communication antenna 19, cutting blades (forward) 20, cutting blades (rear) 21, driving wheels 22, steering wheels 23, an operation input unit 24, a display unit 25, and a audio output unit 26.

The control device 11 is configured by: a computer device provided with a CPU, a communication function, a storage function (drive unit and/or input-output interface for an internal recording medium as well as external recording medium) and a display function (display); and a predetermined computer program. This computer program causes the computer device to function as a GPS receiving unit 101, a sending/receiving unit 102, a vehicle information receiving unit 105, a drive command unit 106, a control information generating unit 107, a storage unit 108, a removable recording medium interface unit 109, and a main control unit 112. The main control unit 112 generally controls the operation of each unit. This computer device is provided with a RTC (Real Time Clock) module which outputs time data and a control operation synchronizing clock. The control device 11 may also be provided with an azimuth velocity sensor for the case where the lawn mower is not provided with an azimuth velocity sensor etc. Details of the control device 11 are mentioned below.

The vehicle velocity sensor 12 detects the travelling speed during the forward advance or backward retreat of the lawn mower 1. The azimuth velocity sensor 13 detects (dynamic) behaviors of the lawn mower 1 such as tilting, turning and wobbling by the angular velocities about a three-dimensional axis (roll, pitch and yaw). The data to be measured by the azimuth velocity sensor 13 may also be substituted by an accelerometer. Moreover, the sensors 11 and 12 can also be substituted by incorporating the measurement results of various kinds of measuring instruments provided in the lawn mower 1.

Three induction line detection sensors of the center induction line detection sensor 15, the left side induction line detection sensor 14 and the right side induction line detection sensor 16, when travelling autonomously on a travelling path on an electromagnetic induction line, detect the strength of an alternating magnetic field generated by means of an alternating current supplied to the electromagnetic induction line.

The drive control unit 17 controls a work drive mechanism which drives the raising/lowering and operation of the cutting blades provided in the lawn mower 1 on the basis of a work control signal mentioned below, and controls a travelling drive mechanism which drives turns to the left/right, forward advance, backward retreat etc. of the lawn mower 1 on the basis of a travelling control signal mentioned below. This drive control unit 17 may be provided separately to the control device 11, as shown in the drawing but may also be achieved as one function of the control device 11.

The GPS antenna 18 functions as a position detection sensor which receives GPS data sent from a GPS satellite. The communication antenna 19 enables communication with the communication antenna 36 of the base station 3. This communication is utilized for correction information for correcting the aforementioned positional information errors of the lawn mower 1, for communication with an operator of the lawn mower 1, and for sending/receiving signals etc. for the remote operation of the lawn mower 1. The operation input unit 24 is configured of a keyboard, a mouse and the like; however, it is not limited to this configuration.

The display unit 25 is configured of a CRT, liquid crystal display, stack display lights and the like; however, it is not limited to this configuration.

The audio output unit 26 is configured of a speaker etc.; however, it is not limited to this configuration.

### <Lawn Mower>

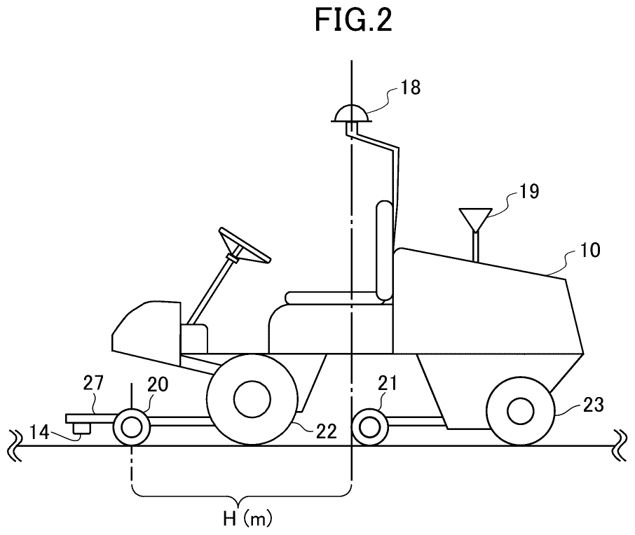

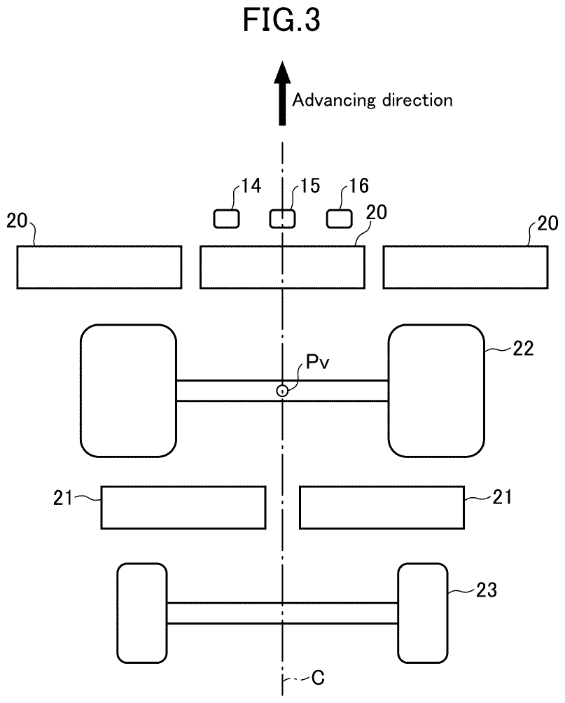

FIG. 2 is an external view of the lawn mower 1 as seen from the side surface. FIG. 3 is an upper surface conceptual drawing of the main components of a lawn mower according to one embodiment of the present invention. The aforementioned control device 11, the vehicle velocity sensor 12, the azimuth velocity sensor 13, the drive control unit 17, the travelling drive mechanism and the work drive mechanism are built into the body 10 of the lawn mower 1.

The azimuth velocity sensor 13 is installed at a position where the behavior of the lawn mower 1 is correctly transmitted. The GPS antenna 18 is provided so as to be the substantially center position of the body of the lawn mower 1; namely, the substantial center respectively of the length direction and the width direction of the body. Moreover, the communication antenna 19 is attached so as to protrude from the rear surface of the body of the lawn mower 1, so as to not become an obstacle for the receiving of the GPS antenna 18.

The three induction line detection sensors which are the center induction line detection sensor 15, the left side induction line detection sensor 14 and the right side induction line detection sensor 16 are attached to a stay 27 which is attached to the cutting blades (forward) 20. The center induction line detection sensor 15 is disposed on a central line C of the lawn mower 1, at a position separated from a pivot Pv positioned at the axle center of the driving wheels 22 serving as the turning center of the lawn mower 1, by a distance I[m] mentioned below. The left side induction line detection sensor 14 and the right side induction line detection sensor 16 are disposed on a straight line perpendicular to the central line C of the lawn mower 1 passing through the center induction line detection sensor 15, at the left side and right side of the center induction line detection sensor 15, at a position separated from the center induction line detection sensor 15 by a distance D[m] mentioned below.

As mentioned above, the lawn mower 1 is provided with a pair of the cutting blades (forward) 20 and the cutting blades (rear) 21 for mowing a lawn. The forward cutting blades 20 mow the left and right edges of a lawn in a mowing width W[m] in a direction orthogonal to the travelling direction. The rear cutting blades 21 mow the center portion of a lawn in a mowing width W[m]. This mowing width W[m] serves as a working width in which a lawn can be mowed by the first time travelling and working of the lawn mower 1.

### <Control Device>

Returning to FIG. 1, the GPS receiving unit 101 of the control device 11 outputs GPS data received by the GPS antenna 18 to the control information generating unit 107. The sending/receiving unit 102 enables communication between the control information generating unit 107 and base station 3 via the communication antenna 19, and outputs correction information for correcting errors of the positional information of the lawn mower 1 received by the communication antenna 19 to the control information generating unit 107. The control information generating unit 107 generates positional information which expresses the present position of the lawn mower 1, on the basis of the correction information for correcting errors of the GPS data received by the GPS antenna 18 and of the positional information of the lawn mower 1 received by the communication antenna 19. Moreover, the sending/receiving unit 102 can be connected to any network regardless of whether by wire or wireless, or whether by a LAN (Local Area Network) or a public communication trunk line.

The vehicle information receiving unit 105 acquires detected information which expresses the travelling speed, the orientation and the behavior of the lawn mower 1 from the vehicle velocity sensor 12 and the azimuth velocity sensor 13, and/or from position tracking by means of GPS data. If the acquired information is analogue data, this data is converted to digital data and is output. In that case, data correction takes place as necessary by subjecting this data to removal processing etc. of offset components and drift components from the output of the azimuth velocity sensor 13. Moreover, the vehicle information receiving unit 105 acquires a magnetic field strength by means of the center induction line detection sensor 15, the left side induction line detection sensor 14 and the right side induction line detection sensor 16. The output information of the vehicle information receiving unit 105 is recorded in the storage unit 108 in association with present time data.

On the basis of the output information (the travelling control signal/work control signal) of the control information generating unit 107, the drive command unit 106 outputs, to the drive control unit 17, information defining the control content of the travelling drive mechanism or work drive mechanism in order to perform travelling control or work control of the lawn mower 1. On the basis of this information, the drive control unit 17 controls the travelling drive mechanism or the work drive mechanism of the lawn mower. Thereby, the autonomous travelling by means of the lawn mower 1 and the lawn mowing work by means of autonomous travelling are enabled.

The storage unit 108 can record the travelling path and operation data, or a predetermined computer program etc. The storage unit 108 is configured of any number of storage components such as a hard disk and semiconductor memory; however, it is not limited to this configuration.

An optical disk such as a CD-ROM and DVD, or a removable recording medium such as USB memory and SD memory card etc. can be attachably and detachably mounted in the removable recording medium interface unit 109. Moreover, the removable recording medium interface unit 109 can read out data recorded in the mounted removable recording medium 40, and write in data in the removable recording medium 40. In the removable recording medium interface unit 109, the removable recording medium 40 is, for example, a dedicated reader/writer etc. if for an optical disk such as a CD-ROM and DVD, a USB port etc. if for a USB memory, and a card slot etc. if for a SD memory card; however, the removable recording medium interface unit 109 is not limited to them.

The travelling path and the operation data are recorded in the removable recording medium 40 mounted in the storage unit 108 or removable recording medium interface unit 109. The operation data includes, in association with the travelling path, various kinds of settings in relation to the lawn mowing work including the start or stop etc. of the raising/lowering action and rotation of the cutting blades (forward) 20 and the cutting blades (rear) 21 during travel or during stoppage of the lawn mower 1, and also includes the speed and autonomous travelling mode of the lawn mower 1. The autonomous travelling mode includes a positioning mode which performs autonomous travelling on the basis of a received positioning signal, and an electromagnetic induction mode which detects a magnetic field generated from an electromagnetic induction line to perform autonomous travelling along said electromagnetic induction line. When in the positioning mode, the control information generating unit 107 generates and outputs the travelling control signal and the work control signal, on the basis of the travelling path and the operation data, as well as the present position acquired by GPS data and various kinds of sensors 11 etc. However, in the electromagnetic induction mode, the control information generating unit 107 generates and outputs the travelling control signal and the work control signal on the basis of a deviation of the lawn mower 1 from an electromagnetic induction line E, calculated from the magnetic field strength acquired by means of the center induction line detection sensor 15, the left side induction line detection sensor 14 and the right side induction line detection sensor 16. Work by means of autonomous travelling is thereby enabled.

### <Steering Control System>

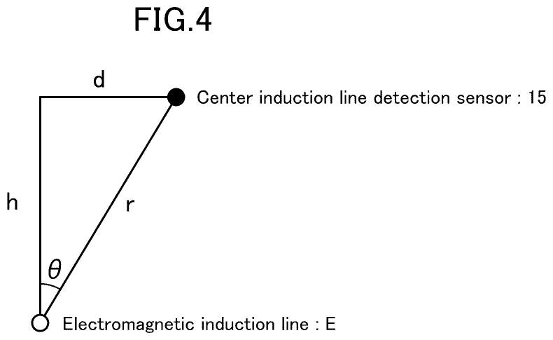

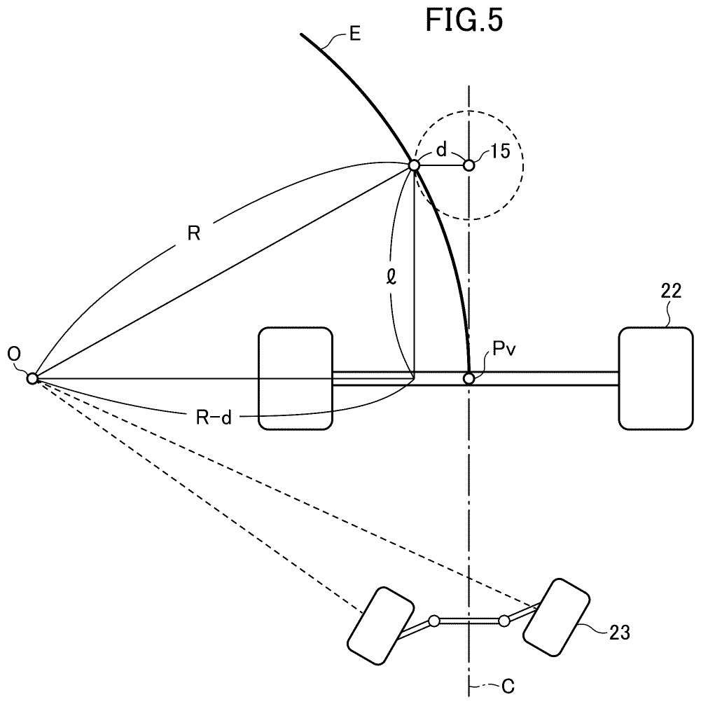

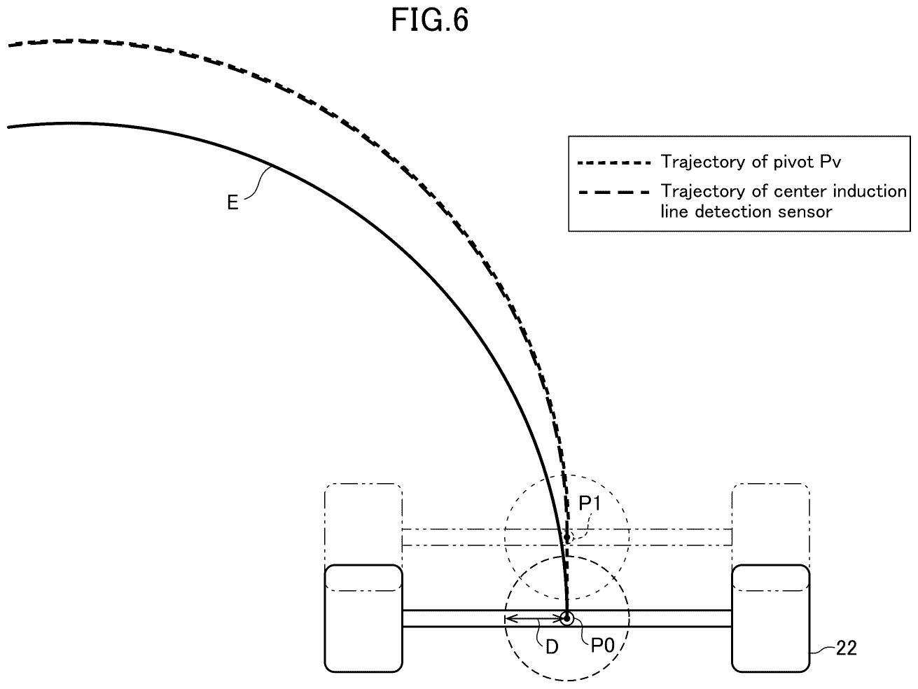

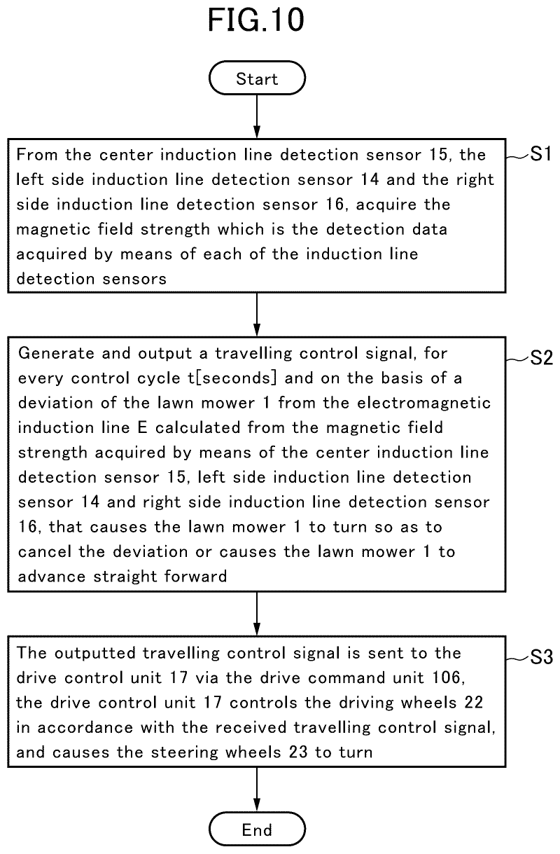

Next, the steering control system and the method according to one embodiment of the present invention will be explained. Firstly, the theoretical principle thereof will be explained. FIG. 4 is a drawing illustrating the relationship between the deviation of the induction line detection sensor from the electromagnetic induction line, and the positional relationship between the electromagnetic induction line and induction line detection sensor. FIG. 5 is a drawing illustrating a geometrical relationship when travelling autonomously on an electromagnetic induction line. FIGS. 6 to 9 are drawings illustrating the relationship between the trajectory of a pivot and the trajectory of the center induction line detection sensor. FIG. 10 is a flowchart of an example of a steering control process according to one embodiment of the present invention.

A steering control system 60 includes the control device 11, the center induction line detection sensor 15, the left side induction line detection sensor 14 and the right side induction line detection sensor 16.

FIG. 4 is a drawing illustrating the relationship between the deviation of the induction line detection sensor from the electromagnetic induction line, and the positional relationship between the electromagnetic induction line and induction line detection sensor, in a perpendicular cross-section in the advancing direction of the lawn mower 1. Referring to FIG. 4, if the height of the perpendicular direction from the electromagnetic induction line E to the center induction line detection sensor 15 is configured to be h[m], the deviation in the horizontal direction of the center induction line detection sensor 15 from the electromagnetic induction line E; namely, the distance of the horizontal direction from the electromagnetic induction line E to the center induction line detection sensor 15 is configured to be d[m], and the angle formed between the straight line of the vertical direction passing through the electromagnetic induction line and the center induction line detection sensor 15 is configured to be θ, then the distance from the electromagnetic induction line E to the induction line detection sensor 15 (radius of the line of magnetic force) r[m] is r=d/sin θ[m].

If the height h[m] of the perpendicular direction from the electromagnetic induction line E to the center induction line detection sensor 15 is deemed to be constant, then d=r·sin θ[m] and hence the value of the distance d of the horizontal direction from the electromagnetic induction line E to the center induction line detection sensor is proportional to the distance r[m] from the electromagnetic induction line E to the center induction line detection sensor 15. Moreover, since the strength of the magnetic field emanating from the electromagnetic induction line E is inversely proportional to the distance r[m] from the electromagnetic induction line E to the center induction line detection sensor 15, the magnetic field detected by the center induction line detection sensor 15 becomes weak to the extent that r[m] becomes large. Accordingly, the center induction line detection sensor 15 can determine a maximum detectable value of r[m] if configured so as to not detect a signal of a threshold value strength or lower. Since the value of d[m] is proportional to the value of r[m], the center induction line detection sensor 15 can also determine the maximum detectable value of d[m]. This maximum detectable distance in the horizontal direction d[m] will be called the maximum detection distance D[m]. In the present embodiment, the detection capability of the left side induction line detection sensor 14 and the right side induction line detection sensor 16 is the same, and the maximum detection distances are also configured to be D[m].

As mentioned above, the center induction line detection sensor 15 is disposed on the central line C of the lawn mower 1, at a position separated from the pivot Pv by a distance I[m]. The left side induction line detection sensor 14 and the right side induction line detection sensor 16 are disposed on a straight line perpendicular to the central line C of the lawn mower 1 passing through the center induction line detection sensor 15, at the left side and right side of the center induction line detection sensor 15, at a position separated from the center induction line detection sensor 15 by a maximum detection distance D[m]. Since the detection capabilities of the center induction line detection sensor 15, the left side induction line detection sensor 14 and the right side induction line detection sensor 16 are identical, a deviation of the position of the center induction line detection sensor 15 from the electromagnetic induction line E can be detected by means of such a disposition.

The control information generating unit 107 of the control device 11 calculates the deviation of the lawn mower 1 from the electromagnetic induction line E acquired by means of the vehicle information receiving unit 105, on the basis of the magnetic field strength which is the detection data acquired by means of the center induction line detection sensor 15, the left side induction line detection sensor 14 and the right side induction line detection sensor 16. Specifically, if the center induction line detection sensor 15 detected no magnetic field and the left side induction line detection sensor 14 detected a magnetic field, it can be determined that the electromagnetic induction line E has deviated so as to be positioned at the left side of the left side induction line detection sensor 14. Moreover, if the center induction line detection sensor 15 detected no magnetic field and the right side induction line detection sensor 16 detected a magnetic field, it can be determined that the electromagnetic induction line E has deviated so as to be positioned at the right side of the right side induction line detection sensor 16. Then, when the center induction line detection sensor 15 detected a magnetic field and the left side induction line detection sensor 14 detected a magnetic field, it can be determined that the electromagnetic induction line E has deviated so as to be positioned between the center induction line detection sensor 15 and the left side induction line detection sensor 14. Moreover, when the center induction line detection sensor 15 detected a magnetic field and the right side induction line detection sensor 16 detected a magnetic field, it can be determined that the electromagnetic induction line E has deviated so as to be positioned between the center induction line detection sensor and the right side induction line detection sensor 16.

However, in the present embodiment, a deviation tolerance width which causes the lawn mower 1 to stop if the lawn mower 1 (more strictly speaking, the position of the center induction line detection sensor 15) has deviated further from the electromagnetic induction line E is set as the maximum detection distance D[m], and the center induction line detection sensor 15 detected no magnetic field, the control information generating unit 107 generates a travelling control signal to cause the lawn mower 1 to stop, which thereby causes the lawn mower 1 to stop.

The calculation of the deviation of the lawn mower 1 from the electromagnetic induction line E is not limited to the configuration which is calculated by the control information generating unit 107, but can also be suitably configured in any other way; for example, by a configuration in which a deviation is calculated by an outside portion of the control device 11, and the calculated deviation is received by the control device, etc.

Moreover, a deviation from the electromagnetic induction line E of the center point of the position of the left side induction line detection sensor 14 and the position of the right side induction line detection sensor 16 can be calculated, even without disposing the center induction line detection sensor 15 and only by means of the left side induction line detection sensor 14 and the right side induction line detection sensor 16. Hence, a configuration may also have no center induction line detection sensor 15 disposed.

Referring to FIG. 5, when steering of the lawn mower 1 has taken place, the lawn mower 1 moves so that the pivot (control point) Pv passes through a circular arc track whose radius R is configured as the point where the normal vectors of the steering wheels intersect (turning center O). Here, although the left side induction line detection sensor 14 and the right side induction line detection sensor 16 are necessary in the actual control, since these have no influence on the disposed position range of the of the lawn mower 1 in the front and rear direction of the center induction line detection sensor 15 considered below, these are omitted in FIG. 5.

As mentioned above, the control information generating unit 107 generates and outputs the travelling control signal on the basis of a deviation of the lawn mower 1 from the electromagnetic induction line E calculated from the magnetic field strength acquired by means of the center induction line detection sensor 15, left side induction line detection sensor 14 and the right side induction line detection sensor 16. Specifically, the control information generating unit 107 generates and outputs the travelling control signal, for every control cycle t[seconds] and on the basis of a deviation of the lawn mower 1 from the electromagnetic induction line E calculated from the magnetic field strength acquired by means of the center induction line detection sensor 15, the left side induction line detection sensor 14 and the right side induction line detection sensor 16, that causes the lawn mower 1 to turn so as to cancel the deviation or causes the lawn mower 1 to advance straight forward. The outputted travelling control signal is sent to the drive control unit 17 via the drive command unit 106, and the drive control unit 17 controls the driving wheels 22 in accordance with the received the travelling control signal, and causes the steering wheels 23 to turn.

In the present embodiment, the lawn mower 1 is configured not to move in reverse when travelling on an electromagnetic induction line.

The disposed position range of the lawn mower 1 in the front and rear direction of the center induction line detection sensor 15 for enabling the lawn mower 1 to travel autonomously without deviating from an electromagnetic induction line is considered in the above premise. Here, since the lawn mower 1 cannot turn with a turning radius smaller than the smallest turning radius, a travelling path cannot include a curve having a curvature radius smaller than the smallest turning radius. Moreover, conversely, the lawn mower 1 can travel with a curve having the smallest turning radius or greater. Accordingly, a travelling path at the limit of whether the lawn mower 1 is capable of autonomously travelling without deviating from an electromagnetic induction line may be considered to be a circular arc having a radius configured as the smallest turning radius. In other words, if the lawn mower 1 is capable of autonomous travelling without deviating from an electromagnetic induction line of a circular arc having a radius configured as the smallest turning radius, then a travelling path which does not include curve having a curvature radius smaller than the smallest turning radius is capable of autonomous travelling. Accordingly, the case where a travelling path is a circular arc having the smallest turning radius configured as the radius is discussed as follows.

### (When on the Pivot Pv)

Firstly, the case where the center induction line detection sensor 15 is on the pivot Pv is considered.

Referring to FIG. 6, when the center induction line detection sensor 15 is at the initial position P0, the control information generating unit 107 does not detect a deviation, and hence no steering takes place in the steering control system 60 and the lawn mower 1 advances straight forward. When the velocity of the lawn mower 1 travelling on the electromagnetic induction line E was configured to be v[m/seconds], after one control cycle; namely, after t seconds, the pivot Pv and the center induction line detection sensor 15 become the position P1 which advanced straight forward from the initial position P0 by tv[m].

At this timing after one control cycle, since the control information generating unit 107 detects a deviation from the electromagnetic induction line E, the steering control system 60 steers the lawn mower 1 so as to come close to the electromagnetic induction line with the smallest turn; namely, so as to turn to the left side with the smallest turning radius. However, since the pivot Pv is at position P1 at this time, as understood from FIG. 6, the lawn mower 1 cannot come close to the electromagnetic induction line E even by turning with the smallest turn, and hence the lawn mower 1 cannot return to the electromagnetic induction line E. Namely, since the timing of the turn is too late, the lawn mower 1 cannot return to the electromagnetic induction line E.

Accordingly, if the position of the lawn mower 1 was deviated from the electromagnetic induction line E, it is necessary to hasten the timing of the turn in order for the lawn mower 1 to be able to return to the electromagnetic induction line E. In order to do so, although it is necessary to dispose the center induction line detection sensor 15 at a more forward side than the pivot Pv, the question of how much distance this should be disposed forward so that the lawn mower 1 can return to the electromagnetic induction line E is discussed below.

(Closest Disposition from the Pivot Pv)

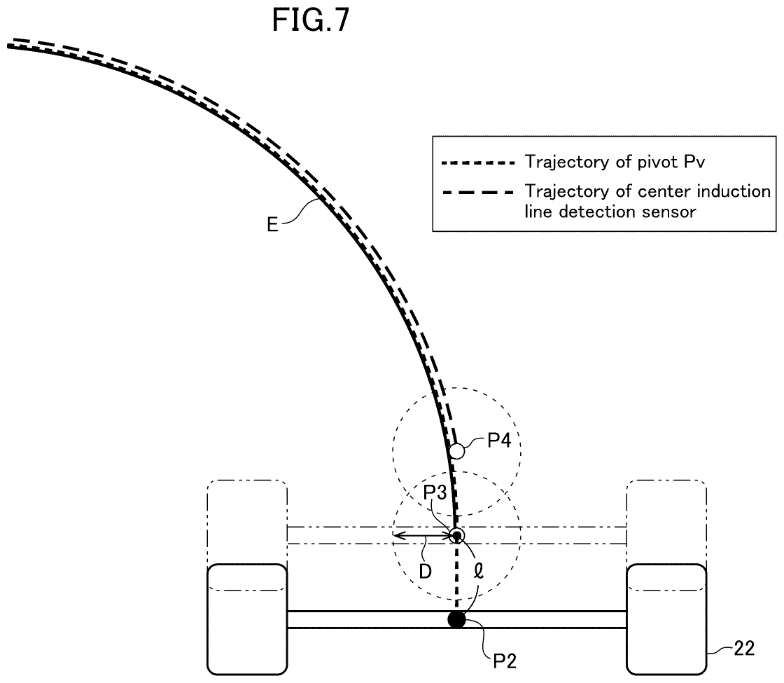

Firstly, the closest disposition from the pivot Pv is discussed. Referring to FIG. 7, the case where I=tv[m]; namely, the case where the center induction line detection sensor 15 is disposed being separated from the pivot Pv on the central line C of the lawn mower 1 by a distance tv[m] is considered. The initial position of the pivot Pv is configured to be P2, and the initial position of the center induction line detection sensor is configured to be P3. In the initial position, the center induction line detection sensor 15 is at a position on the electromagnetic induction line E, and the center induction line detection sensor 15 does not detect a deviation; hence, no steering takes place in the steering control system 60, and the lawn mower 1 advances straight forward. After one control cycle; namely, after t seconds, the pivot Pv and the center induction line detection sensor 15 are at the position P3 and P4 straight forward from the initial positions P2 and P3 respectively by tv[m], straight forward along the center line of the lawn mower 1 at the initial position.

At this timing after one control cycle, since the center induction line detection sensor 15 detects that the position of the center induction line detection sensor 15 has deviated to the right side from the electromagnetic induction line E, the steering control system 60 steers the lawn mower 1 so as to come close to the electromagnetic induction line with the smallest turn; namely, so as to turn to the left side with the smallest turning radius. Since the pivot Pv is at the position P3 at this time, as understood from FIG. 7, the lawn mower 1 turns by the smallest turn, and can thereby travel on the electromagnetic induction line E without deviating from the electromagnetic induction line E.

Moreover, it can be understood by the comparison of FIGS. 6 and 7 that if the center induction line detection sensor 15 is only separated from the pivot Pv by a distance smaller than that of tv[m], the lawn mower 1 cannot return to the electromagnetic induction line E.

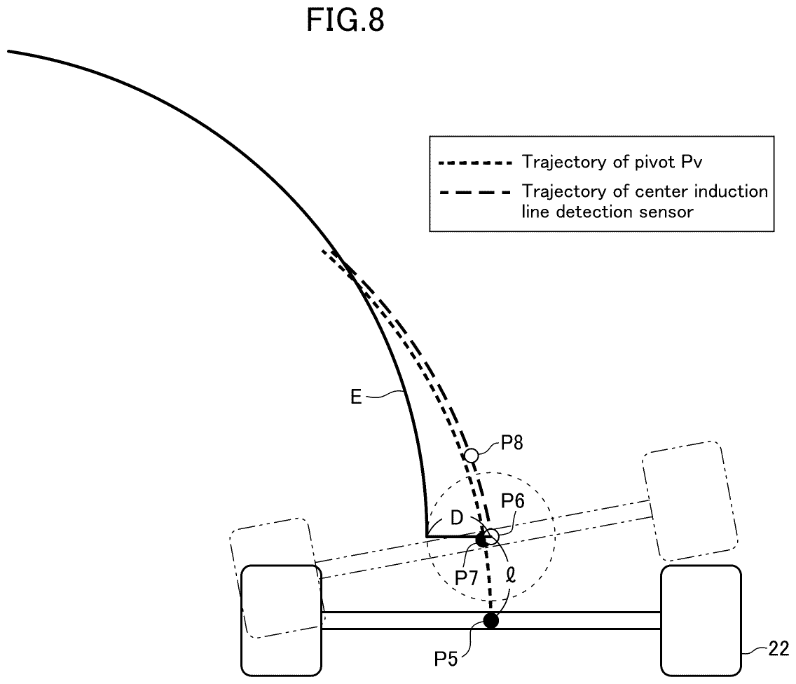

Meanwhile, referring to FIG. 8, in such a disposal of the center induction line detection sensor 15, the case where the center induction line detection sensor 15, in the initial position, is at a location separated by a distance D[m] in a perpendicular direction to the central line C of the lawn mower 1 at the right side, is considered. The initial position of the pivot Pv is configured to be P5, and the initial position of the center induction line detection sensor 15 is configured to be P6. In the initial position, the center induction line detection sensor 15 detects that the position of the center induction line detection sensor 15 has deviated to the right side from the electromagnetic induction line E, and hence the steering control system 60 steers the lawn mower 1 so as to come close to the electromagnetic induction line with the smallest turn; namely, so as to turn at the left side with the smallest turning radius. The position of the pivot Pv after one control cycle; namely, after t seconds, advances on the circumference of the smallest turning radius R by a distance tv[m] to become position P7. The position of the center induction line detection sensor 15, separated from the position P7 in the forward direction by tv[m] in the tangential direction of the circumference of the smallest turning radius R in the position P7, becomes position P8. In the position P8, since the position of the center induction line detection sensor 15 is still deviated from the electromagnetic induction line E to the right side, the control information generating unit 107 detects that the position of the center induction line detection sensor 15 has deviated from the electromagnetic induction line E to the right side. Hence the steering control system 60 steers the lawn mower 1 again, so as to come close to the electromagnetic induction line with the smallest turn; namely, so as to turn at the left side with the smallest turning radius. By repeating the steering in this way for every control cycle, the lawn mower 1 can return to the electromagnetic induction line E.

It is understood from the above that, in order for the lawn mower 1 to be capable of autonomous travelling without deviating from an electromagnetic induction line, when disposing the center induction line detection sensor 15 at a place closest from the pivot Pv, the position of the center induction line detection sensor 15 is the position where the center induction line detection sensor 15 is separated from the pivot Pv on the central line C of the lawn mower 1 by a distance tv[m].

(Farthest Disposition from the Pivot Pv)

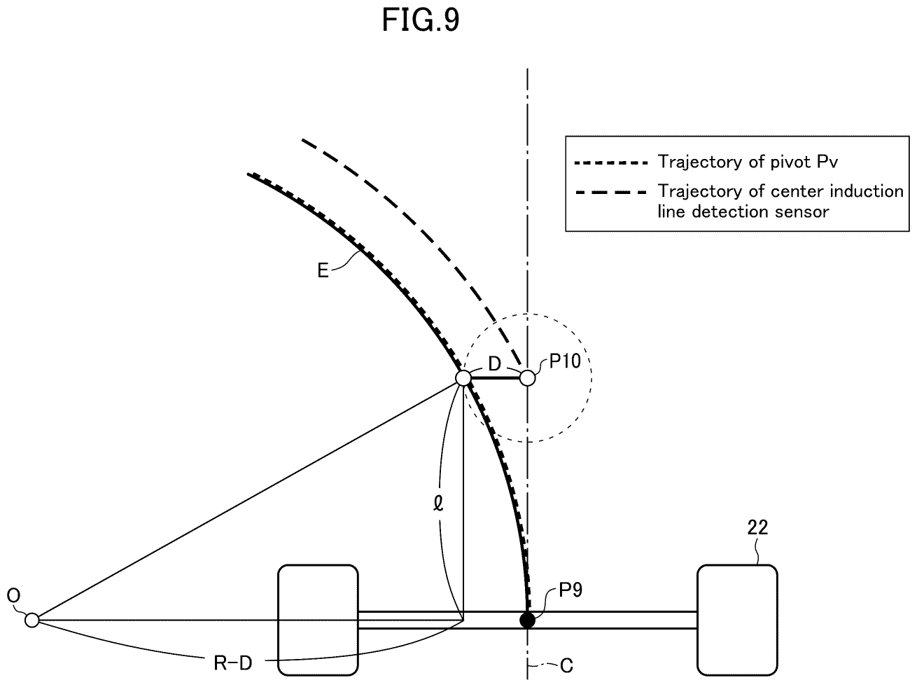

Next, the farthest disposition from the pivot Pv is discussed. Referring to FIG. 9, the case where

$$l = \sqrt{{R}^{2} - {( R - D )}^{2}} ⌈ m ⌉ \qquad [ Formula 3 ]$$

namely, the center induction line detection sensor 15 is disposed separated from the pivot Pv on the central line C of the lawn mower 1 by a distance

$$\sqrt{{R}^{2} - {( R - D )}^{2}} ⌊ m ⌋ , \qquad [ Formula 4 ]$$

and the center induction line detection sensor 15, in the initial position, is at a location separated by a distance of the deviation tolerance width D[m] in the perpendicular direction of the central line C of the lawn mower 1 at the right side, is considered. The initial position of the pivot Pv is configured to be P9, and the initial position of the center induction line detection sensor 15 is configured to be P10. In the initial position, the control information generating unit 107 detects that the position of the center induction line detection sensor 15 has deviated from the electromagnetic induction line E to the right side, and hence the steering control system 60 steers the lawn mower 1 so as to come close to the electromagnetic induction line with the smallest turn; namely, steers the lawn mower 1 so as to turn to the left side with the smallest turning radius. Accordingly, the lawn mower 1 travels on the electromagnetic induction line E of the smallest turning radius. At this time, the trajectory of the center induction line detection sensor 15 becomes parallel to the electromagnetic induction line E of the smallest turning radius R; namely, cannot come close to the electromagnetic induction line E, but also does not become more distant. Accordingly, even if steering so as to turn to the left side with the smallest turning radius for every control cycle, the trajectory of the center induction line detection sensor 15 remains in parallel to the electromagnetic induction line E of the smallest turning radius R.

Accordingly, it is understood that, in order to allow the lawn mower 1 to autonomously travel without deviating from an electromagnetic induction line larger than the deviation tolerance width D[m], the position of the center induction line detection sensor 15 when disposing the center induction line detection sensor 15 farthest from the pivot Pv is the position where the center induction line detection sensor 15 is separated from the pivot Pv on the central line C of the lawn mower 1 by a distance

$$\sqrt{{R}^{2} - {( R - D )}^{2}} ⌈ m ⌉ . \qquad [ Formula 5 ]$$

It is understood from the above that if the center induction line detection sensor 15 is disposed such that I[m] is configured to be tv[m] or greater and

$$\sqrt{{R}^{2} - {( R - D )}^{2}} [ m ] \qquad [ Formula 6 ]$$

or less, then the lawn mower 1 can be controlled so as to be able to return to the electromagnetic induction line E even if deviating from the electromagnetic induction line E.

In the above explanation, the deviation of the position of the center induction line detection sensor 15 from the electromagnetic induction line E is detected by means of the three induction line detection sensors of the center induction line detection sensor 15, the left side induction line detection sensor 14 and the right side induction line detection sensor 16. Namely, the detection reference point of the deviation from the electromagnetic induction line E, detected by means of the three induction line detection sensors of the center induction line detection sensor 15, the left side induction line detection sensor 14 and the right side induction line detection sensor 16, is at the position of the center induction line detection sensor 15. Accordingly, it is also commonly understood that if a plurality of induction line detection sensors are attached to a vehicle, and if the detection reference point of a deviation from the electromagnetic induction line E detected by means of the plurality of induction line detection sensors satisfies the aforementioned conditions (tv[m] or greater and

$$\sqrt{{R}^{2} - {( R - D )}^{2}} [ m ] \qquad [ Formula 7 ]$$

or less) and is disposed at a position separated from the pivot, at the forward side by a distance I[m] in the horizontal direction, then autonomous travelling is enabled without the detection reference point of the deviation deviating from the electromagnetic induction line by larger than the deviation tolerance width D[m].

An example of the steering control method according to one embodiment of the present invention will be explained on the premise of the above theoretical principle.

The vehicle information receiving unit 105 acquires the magnetic field strength, which is the detection data acquired by each of the induction line detection sensors, from the center induction line detection sensor 15, left side induction line detection sensor 14 and right side induction line detection sensor 16 (S1).

The control information generating unit 107 generates and outputs a the travelling control signal that, for every control cycle t[seconds] and on the basis of a deviation of the lawn mower 1 from the electromagnetic induction line E calculated from the magnetic field strength acquired by means of the center induction line detection sensor 15, left side induction line detection sensor 14 and right side induction line detection sensor 16, causes the lawn mower 1 to turn so as to cancel the deviation, or causes the lawn mower 1 to advance straight forward (S2). The outputted travelling control signal is sent to the drive control unit 17 via the drive command unit 106, and the drive control unit 17 controls the driving wheels 22 in accordance with the received travelling control signal, and causes the steering wheels 23 to turn (S3).

In the present embodiment, a configuration of an induction line detection sensor is that of which a detection reference point of a deviation from the electromagnetic induction line E, detected by means of the three induction line detection sensors of the center induction line detection sensor 15, the left side induction line detection sensor 14 and the right side induction line detection sensor 16, is the position of the center induction line detection sensor 15. Moreover, the configuration of an induction line detection sensor is also that of a vehicle where the front wheel is a driving wheel, rear wheel is a steering wheel, and the pivot Pv is positioned at the axle center of the driving wheel. However, the configuration is not limited to such a vehicle. For a vehicle of which the pivot (control point) Pv is uniquely determined, regardless of the drive system (two-wheel drive, three-wheel drive, four-wheel drive, etc.) and steering system (front wheel steering, rear wheel steering), if the detection reference point of a deviation from the electromagnetic induction line E detected by means of a plurality of induction line detection sensors satisfies tv[m] or greater and

$$\sqrt{{R}^{2} - {( R - D )}^{2}} [ m ] \qquad [ Formula 8 ]$$

or less, and is disposed at a position separated from the pivot Pv, at the forward side by a distance I[m] in the horizontal direction, then any suitable configuration of induction line detection sensors and vehicles can be configured.

According to the present embodiment, the lawn mower 1 can be controlled so as not to deviate from an electromagnetic induction line.

In the aforementioned embodiment, the deviation tolerance width is set as the maximum detection distance of the center induction line detection sensor; however, the deviation tolerance width need not be the maximum detection distance of the center induction line detection sensor, and can be configured to be any suitable width.

The function of a portion of steering control system may also be configured as a separate body to the travelling control device, such as a separate server, a base station, and a tablet-type computer.

### <Autonomous Travelling System>

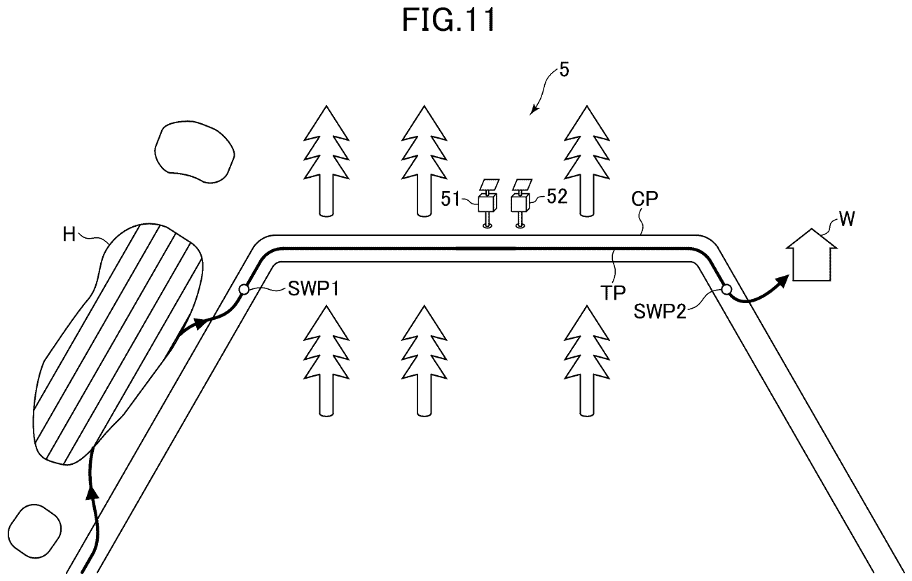

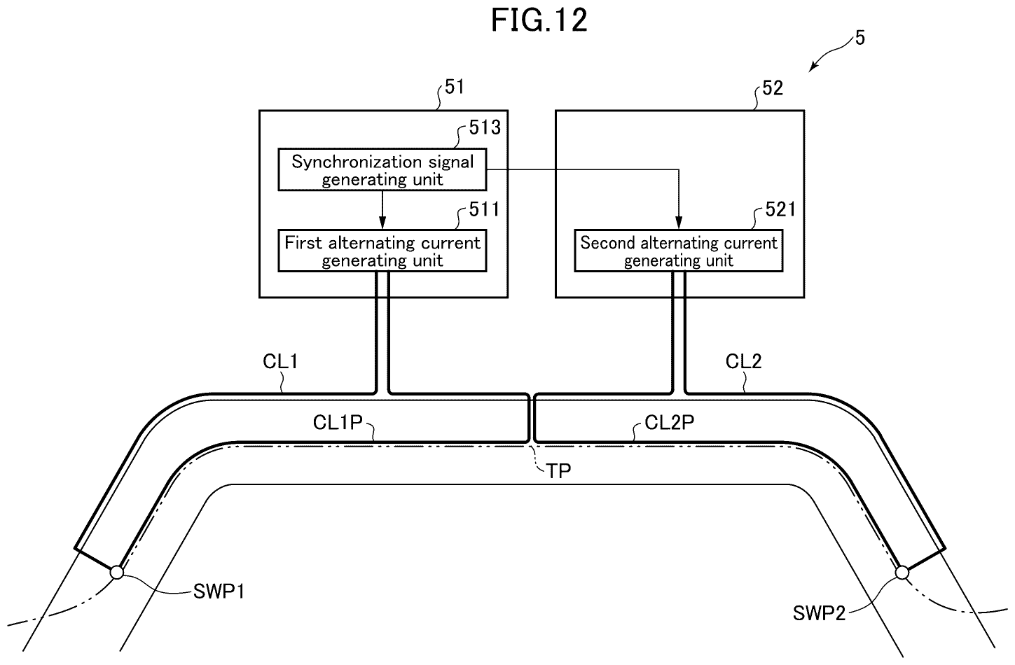

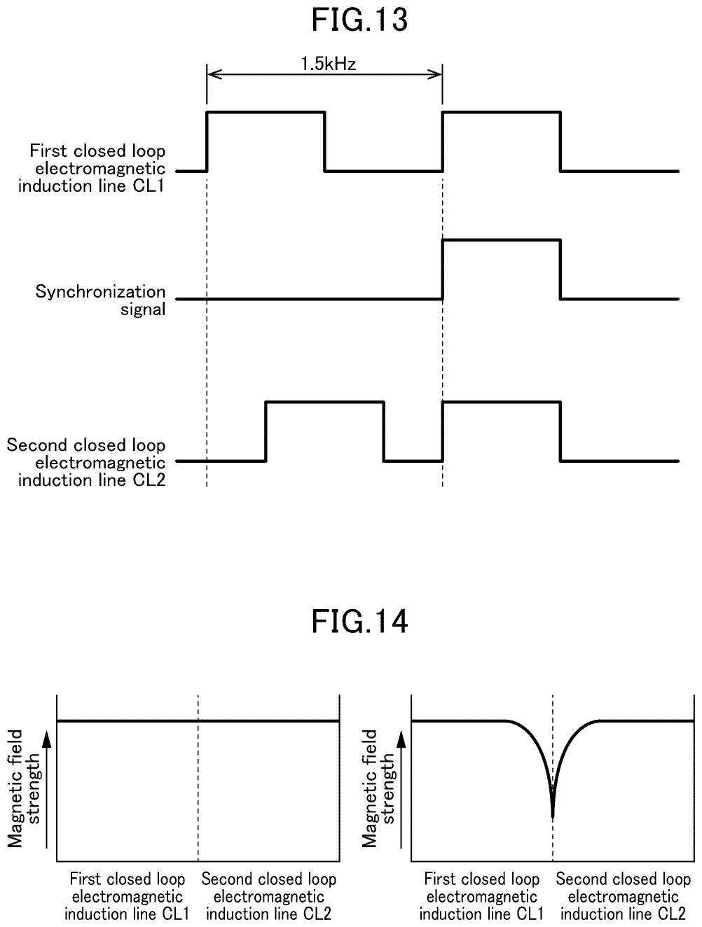

Next, an autonomous travelling system according to one embodiment of the present invention will be explained. FIG. 11 is a drawing illustrating one example of a travelling path. FIG. 12 is a drawing illustrating an entire configuration of the autonomous travelling system according to one embodiment of the present invention. FIG. 13 is a drawing illustrating one example of an alternating current and synchronization signal supplied to an electromagnetic induction line. FIG. 14 is a comparative drawing of the electric field strength when the phases of the alternating current of adjacent closed loop electromagnetic induction lines are matching and when they are shifted.

FIG. 11 is a drawing illustrating one example of a travelling path, wherein illustrated is a travelling path TP entering into a hole H from a cart path CP, performing lawn mowing of the hole H, returning to the cart path CP again from the hole H, advancing on the cart path CP, and entering in a vehicle shed W from the cart path CP. FIG. 12 is a drawing illustrating an enlarged entire configuration of an autonomous travelling system according to one embodiment of the present invention from near the switching point SWP1 to the switching point SWP2.

An autonomous travelling system 5 includes a first closed loop electromagnetic induction line CL1 and second closed loop electromagnetic induction line CL2, and a first power source device 51 and second power source device 52 respectively corresponding to the first closed loop electromagnetic induction line CL1 and the second closed loop electromagnetic induction line CL2. The first closed loop electromagnetic induction line CL1 and second closed loop electromagnetic induction line CL2 are disposed adjacently. The first power source device 51 and second power source device 52 are respectively connected to the corresponding first closed loop electromagnetic induction line CL1 and the second closed loop electromagnetic induction line CL2.

The first power source device 51 is provided with a first alternating current generating unit 511 and a synchronization signal generating unit 513. Moreover, the second power source device 52 is provided with a second alternating current generating unit 521. The first alternating current generating unit 511 and second alternating current generating unit 521 generate a low-frequency alternating current of the same frequency. In the present embodiment, a 1.5 kHz rectangular wave alternating current is generated as illustrated in FIG. 13 for example; however, there is no limitation on this, and the frequency of the alternating current generated can be configured to be any other suitable low frequency. Moreover, the shape of the alternating current generated can be configured to be an alternating current of any other suitable shape.

The synchronization signal generating unit 513 generates a synchronization signal at a predetermined timing. A synchronization signal generated by the synchronization signal generating unit 513 is supplied to the second alternating current generating unit 521, and the second alternating current generating unit 521 generates a rectangular wave alternating current synchronized with the rectangular wave alternating current generated by means of the first alternating current generating unit 511, on the basis of this synchronization signal, and at a predetermined timing. The rectangular wave alternating current generated in this way and by predetermined timing, by means of the first alternating current generating unit 511 and the rectangular wave alternating current generated by means of the second alternating current generating unit 521, are synchronized.

The travelling path TP from switching point SWP1 to switching point SWP2 is on the electromagnetic induction line. Specifically, a first portion CLIP of first closed loop electromagnetic induction line CL1 and a first portion CL2P of the second closed loop electromagnetic induction line CL2 are disposed adjacently to each other so as to form the travelling path TP. At both ends of the first portion CLIP of first closed loop electromagnetic induction line CL1 and both ends of the first portion CL2P of second closed loop electromagnetic induction line CL2, the first closed loop electromagnetic induction line CL1 and the second closed loop electromagnetic induction line CL2 are bent at right angles, where the bent portions become a straight line shape on the cart path CP. By this configuration, the first closed loop electromagnetic induction line CL1 and the second closed loop electromagnetic induction line CL2 are made to be in proximity and adjacent, and hence the interval between the electromagnetic induction lines on the travelling path TP can become smaller. Moreover, it can be prevented that the lawn mower 1 is lead not to the direction of the travelling path TP, but to the bent direction of the first closed loop electromagnetic induction line CL1 and the second closed loop electromagnetic induction line CL2.

Since the first closed loop electromagnetic induction line CL1 and the second closed loop electromagnetic induction line CL2 are made so as to be in proximity and adjacent in this way, if there is a shift in the phase of the alternating current generated by means of the first alternating current generating unit 511 and the alternating current generated by means of the second alternating current generating unit 521, as illustrated on the right side drawing of FIG. 14, the alternating magnetic fields generated from alternating currents near each other at adjacent sections would partially cancel out each other, the magnetic field strength would be reduced, and each of the induction line detection sensors would not be able to detect a magnetic field, and hence continuing the travel would be difficult. Accordingly, if it is not the case that the alternating current generated by means of the first alternating current generating unit 511 and the alternating current generated by means of the second alternating current generating unit 521 are highly precise and have substantially no phase shift, then as mentioned above, the alternating current generated by means of the first alternating current generating unit 511 and alternating current generated by means of the second alternating current generating unit 521 would be made to be synchronized by means of a synchronization signal. Thereby, the reduction of the magnetic field strength near adjacent sections (refer to the left side drawing of FIG. 14) can be suppressed, and the continuation of travel can be enabled.

In the aforementioned embodiment, there were two adjacent closed loop electromagnetic induction lines configuring the travelling path TP; however, there is no limitation on the number of adjacent closed loop electromagnetic induction lines configuring the travelling path TP, which can be suitably configured to be any other number.

Switching points SWP1 and SWP2 are set to positions where a positioning signal can be well-received from a GPS satellite, and in the aforementioned autonomous travelling system 5, the lawn mower 1 travels autonomously along a travelling path where the autonomous travelling mode is set as the positioning mode. When the lawn mower 1 arrives at the switching point SWP1, the autonomous travelling mode switches over from the positioning mode to the electromagnetic induction mode, and autonomous travelling by means of electromagnetic induction takes place. Then, when the lawn mower 1 arrives at the switching point SWP2, the autonomous travelling mode switches over from the electromagnetic induction mode to the positioning mode, and autonomous travelling by means of positioning (GPS) takes place and the lawn mower heads towards the vehicle shed W. The switching of the autonomous travelling mode takes place by means of the travelling control signal generated by the control information generating unit 107, on the basis of the travelling path and the operation data recorded in the removable recording medium 40 mounted in the storage unit 108 or the removable recording medium interface unit 109.

According to the aforementioned embodiment, a power source with a large capacity able to supply electric power to a conventional long-distance electromagnetic induction line is not required, and hence by stringing together closed loop electromagnetic induction lines of the present embodiment, autonomous travelling over a long-distance by means of the electromagnetic induction lines is enabled.

If autonomous travelling takes place on the basis of a positioning signal by means of GPS, the positioning signal must be able to be well-received from a GPS satellite. However, on a golf course for example, there are many places with lots of trees with no good clear view of the sky above. Although the trees blocking the field of vision of the sky above on a fairway where a lawn mower performs lawn mowing work are limited to a small part of the fairway, there are many areas of developed mountainous areas on a cart path between holes. Thus, in addition to the aforementioned trees, the path width is narrow and there is also a large difference between high and low elevations for the cart path between work holes. Travelling can also take place by estimating the self-position from a gyro sensor and vehicle velocity sensor etc. mounted to a lawn mower; however, since road surface undulations and changes in road surface conditions cannot be handled in the aforementioned sections and self-positioning cannot be precisely obtained, autonomous travel on a travelling path is difficult. According to the present embodiment, performing autonomous travelling by switching from the sections where autonomous travelling in such positioning mode is difficult, over to autonomous travelling by the electromagnetic induction mode, autonomous travelling is enabled over all sections, even if a path where a positioning signal such as GPS signal cannot be received or where the receiving strength of a positioning signal is weak, is included in the travelling path.

A recording medium in which a computer program is recorded, which achieves the method of the aforementioned embodiments, may also be supplied to the control device 10. In this case, a computer of the control device 10 reads and executes the computer program recorded in the recording medium, and thereby can achieve the objective of the present invention. Accordingly, since the computer program per se read from the recording medium achieves the method of the present invention, such computer program constitutes the present invention.

In the aforementioned embodiments, an example of having applied the present invention to a lawn mower were explained; however, the present invention can also be applied to any other suitable vehicle such as an agricultural machine, including a water dispersing machine, a scattering machine, a fertilizing machine, a seed sowing machine, a soil condition measuring machine, a harvesting machine, a tilling machine, a soil cultivating machine, a land levelling machine, as well as a cleaning machine and a cart.

In the aforementioned embodiments, the positioning signal employed by the positioning mode was GPS data; however, the positioning signal employed by the positioning mode is not limited to this, and depending on the type of vehicle, can be configured to be any other suitable positioning signals such as a beacon signal, BLE beacon signal, impulse system UWB (IR-UWB) signal, IMES (Indoor Messaging System) signal etc. transmitted from GPS data, or an access point of a wireless LAN, or combination of all or a part thereof.

Several embodiments of the present invention were explained above for exemplification; however, it would be evident to the person skilled in the art that the present invention is not limited to these embodiments, but that a variety of modifications and corrections can be performed on the aspects and details without deviating from the scope and spirit of the present invention.

### REFERENCE SIGNS LIST

1 . . . Lawn mower
10 . . . Main body
11 . . . Control device
12 . . . Vehicle velocity sensor
13 . . . Azimuth velocity sensor
14 . . . Left side induction line detection sensor
15 . . . Center induction line detection sensor
16 . . . Right side induction line detection sensor
17 . . . Drive control unit
18 . . . GPS antenna
19 . . . Communication antenna
20 . . . Cutting blades (forward)
21 . . . Cutting blades (rearward)
22 . . . Driving wheels
23 . . . Steering wheels
24 . . . Operation input unit
25 . . . Display unit
26 . . . Audio output unit
27 . . . Stay
101 . . . GPS receiving unit
102 . . . Sending/receiving unit
105 . . . Vehicle information receiving unit
106 . . . Drive command unit
107 . . . Control information generating unit
108 Storage unit
109 . . . Removable recording medium interface unit
112 . . . Main control unit
3 . . . Base station
31 . . . GPS receiving device
32 . . . Sending/receiving device
35 . . . GPS antenna
36 . . . Communication antenna
40 . . . Removable recording medium
5 . . . Autonomous travelling system
51 . . . First power source device
511 . . . First alternating current generating unit
513 . . . Synchronization signal generating unit
52 . . . Second power source device
521 . . . Second alternating current generating unit
60 . . . Steering control system
Pv . . . Pivot
R . . . Smallest turning radius
C . . . Center line of lawn mower
D . . . Maximum detection distance, deviation tolerance width
E . . . Electromagnetic induction line
CP . . . Cart path
H . . . Hole
W . . . Vehicle shed
TP . . . Travelling path
SWP1, SWP2 . . . Switching points
CL1 . . . First closed loop electromagnetic induction line
CL1P . . . First portion of first closed loop electromagnetic induction line CL1
CL2 . . . Second closed loop electromagnetic induction line
CL2P . . . First portion of second closed loop electromagnetic induction line CL2

1-12. (canceled)

13. Autonomous travelling system for a vehicle that detects a magnetic field generated from an electromagnetic induction line and that is capable of autonomous travelling along said electromagnetic induction line, said system comprising:
a plurality of closed loop electromagnetic induction lines disposed adjacent to each other; and
a power source device respectively corresponding to each of said plurality of closed loop electromagnetic induction lines, wherein:
a portion of each of said plurality of closed loop electromagnetic induction lines are disposed adjacent to each other so as form a travelling path; and
a power source device corresponding to each of said plurality of closed loop electromagnetic induction lines are respectively connected, and a low-frequency alternating current of the same frequency is supplied from said power source device to the corresponding closed loop electromagnetic induction line of said plurality of closed loop electromagnetic induction line.

14. Autonomous travelling system according to claim 13, wherein said low-frequency alternating current of the same frequency is synchronized.

15. Autonomous travelling system according to claim 13, wherein said vehicle comprises, as autonomous travelling modes, a positioning mode where autonomous travelling takes place on the basis of a received positioning signal, and an electromagnetic induction mode where autonomous travelling takes place along a electromagnetic induction line by detecting a magnetic field generated from said electromagnetic induction line, wherein
autonomous travelling takes place by said positioning mode on a path where said electromagnetic induction line has not been laid.

16. Autonomous travelling system according to claim 13, wherein said electromagnetic induction line of a travelling path is laid at a portion where a positioning signal cannot be received, or where the receiving strength of a positioning signal is weak.

17. (canceled)
